(19) United States
(12) Patent Application Publication
(10) Pub. No.: US 2012/0158482 A1
(43) Pub. Date: Jun. 21, 2012

(54) Systems and Methods for Managing In-Store Purchases Using Mobile Devices

(76) Inventors: Andrew Paradise, Lincoln, MA (US); Dan R. Preston, Palo Alto, CA (US); Jose H. Mercado, JR., Cambridge, MA (US)

(21) Appl. No.: 13/315,700

(22) Filed: Dec. 9, 2011

Related U.S. Application Data
(60) Provisional application No. 61/423,283, filed on Dec. 15, 2010.

(51) Int. Cl. G06Q 30/02; G06Q 30/06

(52) U.S. Cl. 705/14.25; 705/26.8; 705/26.61

(57) ABSTRACT

In-store, “non” transaction data is captured and analyzed based on consumer interactions with products at the retail location. Using a mobile device, an image is acquired that identifies a product being offered for sale by a retail establishment. The image is transmitted to a purchase server, which, in return sends product information for the product back to the mobile device, where it is displayed to the consumer. An event signifying a decision by the consumer not to purchase the product is identified and information about the non-purchase event is transmitted from the mobile device to the purchase server.

### CROSS-REFERENCE TO RELATED APPLICATIONS

This application claims priority to and the benefit of U.S. provisional patent application with Ser. No. 61/423,283 filed on Dec. 15, 2010 entitled “Systems and Methods for Managing In-Store Purchases Using Mobile Devices.”

### TECHNICAL FIELD OF THE INVENTION

Various embodiments of the invention relate generally to methods and supporting systems for improving retail shopping, and more specifically to methods and systems for facilitating the use of mobile devices to enhance the in-store shopping experience.

### BACKGROUND

Internet-based retail merchants have utilized “online shopping carts” on their ecommerce websites to allow consumers to “shop” throughout the site and “checkout” once completed. One advantage of the online cart is that merchants can capture virtually any consumer events as each action creates a unique record—whether it be a HTTP event, database transaction, script execution, or other data processing result. Many of these events, such as simply viewing a product, are simply not captured as part of the offline, brick-and-mortar shopping experience.

One example of such an event is the so-called “abandoned shopping cart” event. On online sales, an abandoned shopping cart describes an event (or series of events) during which a consumer selects an item places it in their virtual shopping cart—effectively adding the item to their order—but later decides not to complete the purchase. For example, a consumer may add an item to their cart, but later remove it, either in favor of another, similar item or altogether. In other cases, a consumer may simply navigate away from the website, leaving a “full” cart, but not completing any transaction.

Merchants, especially those that derive a majority of their revenue from online sales, are keenly interested in solving the abandoned shopping card dilemma, and spend significant marketing dollars analyzing data generated by these events to increase their conversion rates. Once in a physical store, however, such analysis techniques disappear. Consumers can pick up, view, analyze and even open a product, place it in their basket, and eventually leave the store without making a purchase and the merchant has no information about the event. Such events may provide even more insights into the shopping habits and product preferences of a consumer than online activities, but yet remain unaccounted for.

Recently, advances in mobile technology have enhanced in-store shopping activities by allowing consumers to purchase items in real-time. For example, consumers now have access to applications (“apps”) on mobile devices such as cell phones and personal data assistants that facilitate the identification and purchase of items without physical presentation of the item to a point-of-sale terminal. So-called “scan and buy” apps eliminate the often frustrating experience of waiting in a check out line, and can increase sales by eliminating “buyers remorse”—when consumers remove items from their shopping cart prior to checkout.

### SUMMARY OF THE INVENTION

Using the techniques and systems described herein, merchants will gain access to data related to incomplete purchases, and be able to offer more flexible purchasing and delivery options to consumers shopping in-store. Unlike online shopping experiences during which a consumer's interaction with a product is limited to viewing on a screen (or, in some cases, listening to it if it includes audio) in-store shopping allows a consumer to pick up, touch and inspect a product. For example, a consumer may pick up and scan an item using her mobile device to learn more information about the product (price, warranty, ratings, delivery costs and options, etc.) and decide not to purchase the product. Or, the consumer may use her mobile device to search for a better price for the product at competing stores (either brick and mortar or online). In either case, the “non” transaction not only provides valuable information to the retailer and the brand, but also an opportunity to turn the missed sale into a purchase.

In one aspect, event data resulting from a consumer's behavior at a retail establishment is captured using a mobile device and a purchase server. An image identifying a product being offered for sale by a retail establishment is obtained via an image acquisition component operatively connected to the mobile device. The image is transmitted from the mobile device to the purchase server, and product information including price and description information is received in response. The product information is then displayed on a display of the mobile device. An event in the retail establishment representing a decision by the consumer not to purchase the product is identified, and the event information is transmitted from the mobile device to the purchase server.

The image identifying the product can be any one or more of a number of images, such as a bar code, an image of the product, an image of all or a portion of product packaging, a product name, brand name, and a product number. The product information can be displayed on the mobile device as image, text, or both.

The event representing a decision by the consumer not to purchase the product can include, but is not limited to, the consumer entering or exiting the retail establishment, a determination of the consumer's location, the scanning of a product-identifying image by the consumer, the time that such scanning occurs, the addition or removal of an item to a shopping cart, and the time elapsed since the occurrence of a previous event.

In some embodiments, one or more of a survey, an invitation to a sale, and an offer for a subsequent purchase may be received at the mobile device in response to transmitting the event information to the purchase server.

In another aspect, event data resulting from a consumer's behavior at a retail establishment is captured using a mobile device and a purchase server. An image identifying a product being offered for sale by a retail establishment is obtained via an image acquisition component operatively connected to the mobile device. The image is transmitted from the mobile device to the purchase server, and product information including price and description information is received in response. The mobile device further receives instructions to search for additional product information related to the product. The additional information is then compared with the product information on a display of the mobile device, and the product information is updated based on the comparison.

The updated product information can take the form of an updated product price, and may be based on one or more of, for example, a price difference, the consumer's location, the location of another retail establishment offering the product, the availability of the product from an online retail establishment, and the frequency with which the consumer has scanned a product image. Updating the product information based on the comparison may further include receiving an offer from an offer server at the mobile device.

In some embodiments, a determination is made that the consumer has decided to accept the offer from the offer server. In such a case, the consumer is then allowed to authorize purchase of the product via the mobile device. In other embodiments, a determination is made that the consumer has not decided to accept the offer. In that case, an updated offer is received at the mobile device from the offer server. If the consumer rejects the updated offer, additional offers may be made until either the consumer accepts an updated offer, or an offer limit is reached. The offer limit can be based on one or more factors, for example, the elapsed time since an offer was made, a maximum number of offers, a maximum reduction in price, the consumer's location, and the availability of the product.

In further embodiments, an event in the retail establishment representing a decision by the consumer not to purchase the product is identified, and the event information is transmitted from the mobile device to the purchase server.

In yet another aspect, the invention relates to a system for capturing event data resulting from a consumer's behavior at a retail establishment. The system comprises a mobile device having at least one processor configured to obtain an image identifying a product via an image acquisition component and transmit the image to a purchase server. The processor is further configured to receive product information for the product, including price and description information, identify an event in the retail establishment representing a decision by the consumer not to purchase the product, and transmit the event information to the purchase server.

The image identifying the product can be any one or more of a number of images, such as a bar code, an image of the product, an image of all or a portion of product packaging, a product name, brand name, and a product number. The product information can be displayed on the mobile device as image, text, or both.

The event representing a decision by the consumer not to purchase the product can include, but is not limited to, the consumer entering or leaving the retail establishment, a determination of the consumer's location, the scanning of a product-identifying image by the consumer, the time that such scanning occurs, the addition or removal of an item to a shopping cart, and the time elapsed since the occurrence of a previous event.

In some embodiments, the processor is further configured to receive, in response to transmitting the event information, one or more of a survey, a coupon, an invitation to a sale, and an offer for a subsequent purchase

In another aspect, a system for capturing event data resulting from a consumer's behavior at a retail establishment comprises a mobile device having at least one processor configured to obtain an image identifying a product via an image acquisition component, and transmit the image to a purchase server. The processor is further configured to receive product information for the product, including price and description information, as well as receive instructions to search for additional product information related to the product, compare the product information and the additional product information, and update the product information based on the comparison.

The updated product information can take the form of an updated product price, and may be based on one or more of, for example, a price difference, the consumer's location, the location of another retail establishment offering the product, the availability of the product from an online retail establishment, and the frequency with which the consumer has scanned a product image. Updating the product information based on the comparison may further include receiving an offer from an offer server.

In some embodiments, the processor is further configured to determine the consumer has decided to accept the offer, and allow the consumer to authorize purchase of the product via the mobile device. In other embodiments, the processor is further configured to determine the consumer has decided not to accept the offer, and receive an updated offer from the offer server. If the consumer rejects the updated offer, additional offers may be made until either the consumer accepts an updated offer, or an offer limit is reached. The offer limit can be based on one or more factors, for example, the elapsed time since an offer was made, a maximum number of offers, a maximum reduction in price, the consumer's location, and the availability of the product.

In some embodiments, the processor may be further configured to identify an event in the retail establishment representing a decision by the consumer not to purchase the product, and transmit the event information to the purchase server.

In another aspect, an article of manufacture having computer-readable program portions embodied thereon for capturing event data resulting from a consumer's use of a mobile device at a retail establishment comprises computer-readable instructions for obtaining, via an image acquisition component operatively connected to a mobile device, an image comprising information that identifies a product being offered for sale by a retail establishment. The article further comprises computer-readable instructions for transmitting the image from the mobile device to a purchase server, receiving at the mobile device, in response, product information comprising description and price information for the product, displaying the product information on a display of the mobile device, identifying an event in the retail establishment representing a decision by the consumer not to purchase the product, and transmitting the event information from the mobile device to the purchase server.

In yet another aspect, an article of manufacture having computer-readable program portions embodied thereon for capturing event data resulting from a consumer's use of a mobile device at a retail establishment comprises computer-readable instructions for obtaining, via an image acquisition component operatively connected to a mobile device, an image comprising information that identifies a product being offered for sale by a retail establishment. The article further comprises computer-readable instructions for transmitting the image from the mobile device to a purchase server, receiving at the mobile device, in response, product information comprising description and price information for the product, receiving at the mobile device instructions to search for additional product information related to the product, comparing the product information and the additional product information on a display of the mobile device, and updating the product information based on the comparison.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a block diagram illustrating a system for purchasing items using a mobile device in accordance with various embodiments of the invention.

FIG. 2 is a flow chart illustrating a process for capturing in-store behaviors of consumers using a mobile device to assist them with their shopping in accordance with various embodiments of the invention.

FIG. 3 is another flow chart illustrating a process for capturing in-store behaviors of consumers using a mobile device to assist them with their shopping in accordance with various embodiments of the invention.

FIG. 4 is a block diagram illustrating one possible architecture for a mobile device and a server in accordance with various embodiments of the invention.

### DETAILED DESCRIPTION

The inventors have recognized and appreciated that the use of personal, mobile devices as point-of-sale (“POS”) apparatus provides numerous opportunities to enhance the “in-store” shopping experience for consumers and allows merchants and brand companies to capture and analyze data previously not accounted for. For example, a consumer may select, view, touch, listen to, or otherwise interact with a product in the store, only to decide later that she does not want to purchase the product. Unlike returns, which can be easily tracked as two distinct transactions (a purchase and a return), a “non-purchase” cannot be easily traced. In other instances, the consumer may view a product, and, while deciding whether to make the purchase, use a mobile device to search for a better deal elsewhere. In still other cases, the consumer may decide to purchase multiple products, but, due to various logistical or timing constraints, only want to leave the store with a subset of the products, while having the balance of her order shipped or delivered to her at another time.

Various embodiments of the invention related to methods and systems for enabling the implementation of various “in-store” purchase options, as well as the capture of information related to purchases and non-purchases alike. While specific examples may vary, certain implementations provide an application that may be downloaded to or come as a native application on a consumer mobile device that enables consumers to indicate if and why a purchase may not be consummated, provide delivery checkout instructions, and compare prices and other transaction details across multiple merchants, all while remaining in the store.

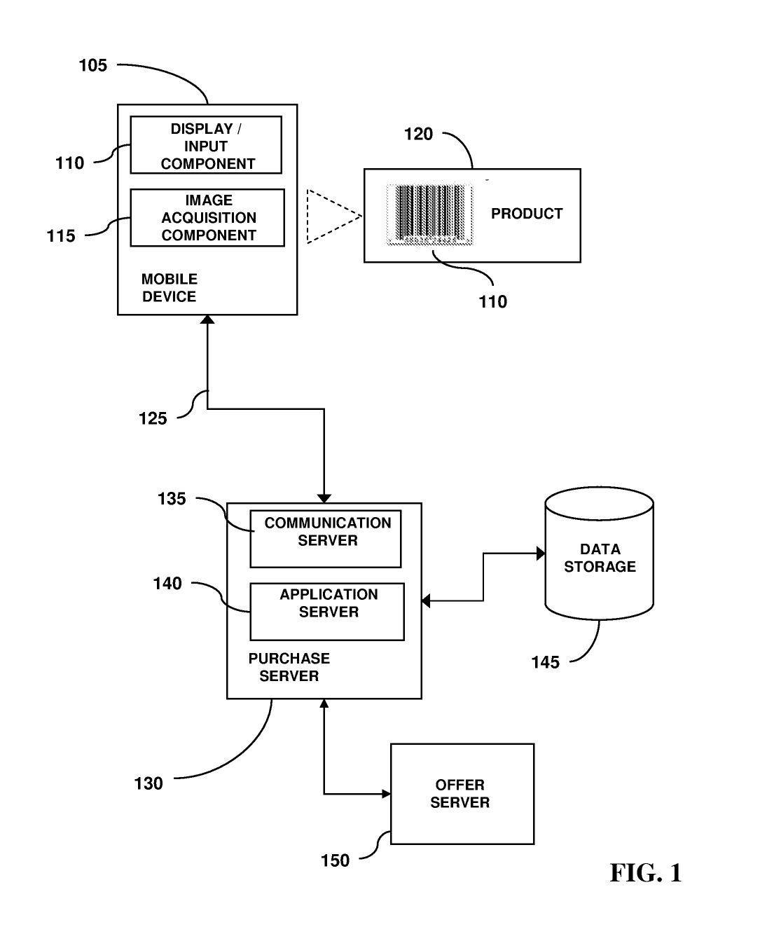

FIG. 1 illustrates an exemplary operating environment 100 in which a mobile device 105 (e.g., a mobile telephone, personal digital assistant, smartphone, or other handheld device such as an iPhone or Android-based device) may be used to purchase a product 110 from a retail establishment, in accordance with some embodiments of the present disclosure. Mobile device 105 may be any mobile device having a processing capability, such as a cellular phone or a personal digital assistant (PDA). Mobile device 105 may be operatively connected to an image acquisition component 115, for example a camera integrated into the mobile device 105. Image acquisition component 115 may be any device component capable of capturing an image of information identifying a product. Such information may include, for example, an image of a bar code (e.g., universal product code (UPC), a matrix barcode (QR code), three-dimensional barcode, or European Article Number (EAN)) on a label 120 affixed to product 110, an image of product 110 itself, an image of all or a portion of the packaging of product 110, or any other image that includes information identifying the product 110. In some embodiments, the image acquisition component 115 may further include optical character recognition capabilities, such that product names, brands, serial numbers, product numbers, or other text-based information may be read, digitally represented, and used in accordance with various implementations of the invention. In the examples below, label 120 is described as being a UPC bar code. However, this provided merely as an example, as label 120 may be any product identifying number (which may be unencoded and/or may be encoded in any suitable barcode or encoded in any other suitable way) or may be any other information usable to identify product 110.

When a user of mobile device 105 intends to purchase a product 110 in a retail establishment, the user may use the image acquisition component 115 of the mobile device 105 to obtain an image that includes the product's UPC label 120 or other information identifying the product 110. The mobile device 105 may be programmed with an application program to communicate with a server 130 to capture events and transactions representing the user's interaction with the product 110 and, if desired, facilitate the purchase of products such as product 110. The application program may be installed on the mobile device in any of a number of ways. For example, the user may download the application program to the mobile device 105 from a developer of the application, from the operator of purchase server 130, from the retail establishment, or from any other suitable source.

Purchase server 130 may have access to any of various image recognition processes by which the UPC code of product 110 may be determined from the image taken of the UPC label 120. Purchase server 130 may also have access to product information for product 110, including, for example, description and price information, through communication with an inventory server (not shown). Once purchase server 130 determines the UPC code of the product 110, purchase server 130 may transmit the corresponding product information to mobile device 105, in response to receiving from the mobile device the image taken of the UPC label 120.

In some alternative implementations, the product information may be provided to the mobile device 105 in advance and the mobile device may be able to retrieve and present the information to a user without having to interact with the server. For example, upon entering a particular store, the mobile device may recognize the store based on the name of a server or wireless network, or based on the user's GPS coordinates. With such information, the device may request all product information for that store such that when the user scans an item the information is readily available. In some cases, only a subset of the product data is sent to the device, based, for example, on which products are most popular, the purchasing habits of the particular user or similar users, etc.

The mobile device 105 and purchase server 130 communicate with each other (as well as other devices and data sources) via a network 125. The network communication may take place via any media such as standard and/or cellular telephone lines, LAN or WAN links (e.g., T1, T3, 56kb, X.25), broadband connections (ISDN, Frame Relay, ATM), wireless links, and so on. Preferably, the network 125 can carry TCP/IP protocol communications, and HTTP/HTTPS requests made by the mobile device and the connection between the mobile device 105 and the server 104 can be communicated over such networks. In some implementations, the network includes various cellular data networks such as 2G, 3G, 4G, and others. The type of network is not limited, however, and any suitable network may be used. Typical examples of networks that can serve as the communications network 125 include a wireless or wired Ethernet-based intranet, a local or wide-area network (LAN or WAN), and/or the global communications network known as the Internet, which may accommodate many different communications media and protocols.

The purchase server 130 many include various functional components, including, for example, a communications server 135 and an application server 140. The communication server provides the conduit through which requests for data and processing are received from the mobile device 105, as well as interaction with other servers that may provide additional product information such as product descriptions, inventory levels, pricing details. The communication server 135 may also transmit product and/or offer information to the mobile device 105 via the network 125. The application server 140 stores and executes the primary programming instructions for facilitating the functions executed on the server 130. Data describing the product(s) and historical event data related to the user, the store, and/or the product may be stored in a separate data storage server 145 for use by the application server 140.

As the user shops, she can use the application program on the mobile device 105 to request information about product(s) she may considering purchasing. For example, she may scan the UPC symbol 120 on the product 110 and receive pricing, warranty, delivery options, reliability or other information about the product that may influence her decision to purchase the product 110. She may use information about the product 110 to search other stores pricing, inventory or other sales parameters using a search application, either separate from the application program or embedded within the application program. She may confirm the purchase, or, in some cases, decide not to purchase the product and place the product back on the shelf. In such cases, she may have performed an “information only” scan (e.g., a scan of the item intended to return information about the item but not place it in the user's shopping cart), or scan the item but not select a “confirm”

The user may enter credit card information and authorization into a user interface of the mobile device 105, and the mobile device 105 may transmit the credit card information and authorization to the purchase server 130 to initiate a purchase of product 110. In some embodiments, purchase server 130 may also be in communication with an offer server 150, in which various offers from manufacturers and/or retailers may be stored in association with products 110 offered for sale by the retail establishment.

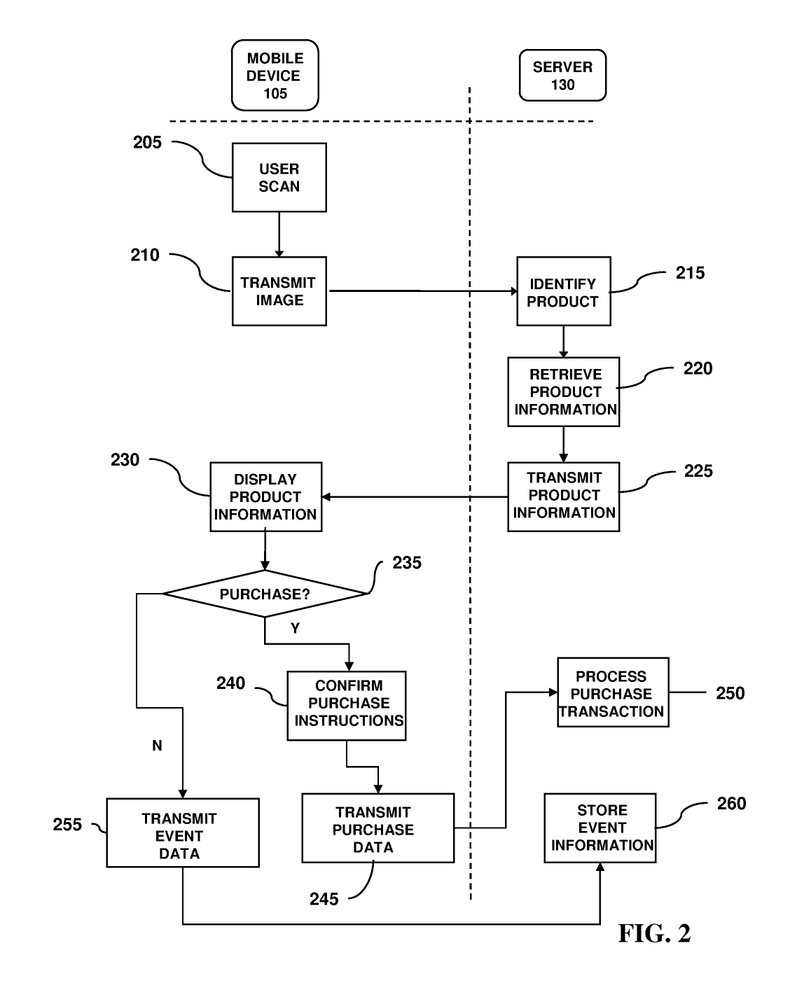

FIG. 2 is a flowchart illustrating a process for capturing user/product interactions at a retail establishment using a mobile device, in accordance with some embodiments of the present disclosure. A user interested in learning more about a product or considering purchasing the product uses initiates an application on her mobile device 105 which provides barcode and scanning functionality. The user scans the image (STEP 205), or in some cases, enters product information manually, and the mobile app transmits the image data to the purchase server 130 (STEP 210). The purchase server processes the image received from mobile device using an image recognition technique to identify the product associated with the transmitted image (STEP 215).

Once the product has been identified, the product information associated with product may be retrieved, for example, from a database either stored on the purchase server or a separate data store (STEP 220) and transmitted to the mobile device (STEP 225) where it is displayed to the user (STEP 230). The product information may be displayed as an image, as a textual message, or a combination of the two.

Having seen the product information, the user may then determine whether to purchase the product or return it to the shelves (DECISION STEP 240). If the user decides to purchase the product, the user can confirm the purchase (STEP 240) by selecting a button or menu option, entering payment instructions (e.g., using PayPal, a credit or debit card, etc.) and/or providing other information related to the purchase. Once entered, the data is transmitted to the server (STEP 245) where it is processed (STEP 250).

Data related to such “non-purchase” events can be used in many ways to enhance the direct sales and marketing efforts of the retail establishments as well as provide insights into purchasing trends of large groups of consumers. In some implementations, the non-purchase event data is used to initiate communications with the user. For example, the user may be sent a survey asking why she did not complete the purchase, what product she purchased instead of the non-purchased item, desired price points, etc. The user may also be sent offers for subsequent purchases such as coupons or invitations to private sales. In addition, the non-purchase event data may be aggregated and/or stripped of any personally identifiable information such that the data becomes anonymous, and used by merchants and product companies for marketing analysis.

In other embodiments, a user's decision not to complete a purchase may be driven by external information, such as product information from other stores (both online and brick-and-mortar). In some cases, her decision may be influenced by receiving offers from a retailer to meet or perhaps beat the pricing and/or other purchase parameters of other stores.

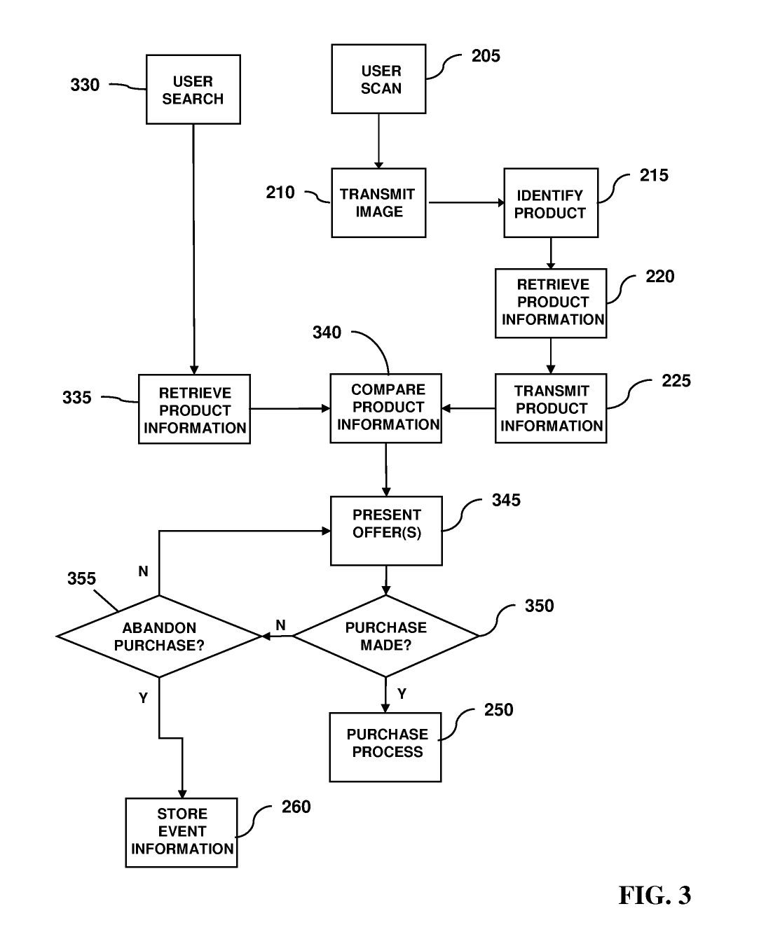

Referring to FIG. 3, a process for product comparison and iterative price matching is illustrated in the context of the system described above. As in the process depicted in FIG. 2, the user scans an item, and the image of that item (or some identifying characteristic associated with the item) is transmitted to the server. The product is identified, product data is retrieved, and sent back the mobile device for viewing by the user.

In addition to the “scan and retrieve” method, a use may also perform an independent search for information about the product. For example, using an application on her mobile device (e.g., Google, Bing, Yahoo! or some other search application), the user may enter a search string in order to view product details (STEP 330). The search string may be the name of the product, a manufacturer, a product code, serial number or other descriptive information (e.g., 50″ LCD HDTV). In some cases, the search application may be embedded within the mobile application described above, such that the information entered by the user and returned by the search application can be captured, analyzed and stored by the mobile application and the supporting purchase server. For example, if a user is in a camera store looking at cameras and enters “Canon PowerShot G12” the search application may return a listing of retail establishments that have that particular model available an the price at which it is being offered. Using nested browsers and scripting, the product and price information may be “harvested” from the results. In one particular example, javascript-based browser extensions (e.g., greasemonkey) may be used to scrape data from the results and reformat the product information into an easily readable format.

By providing such a function, the user may compare product information (STEP 340) across multiple retailers, including the retailer at which they are currently shopping. In cases in which the user hesitates to purchase the item in store, indicates she is no longer interested, or navigates to another store's website using the embedded search application, the mobile application can capture these events as use one or more as a trigger to present offers to the user. Continuing with the example above, as the user scans the Canon camera, she may also enter the model number into a browser application on her mobile device. The resulting screen indicates that another store has the same camera for $25 less, and this information is presented to the user. The mobile application running on her device recognizes the price difference, and, using data previously created and stored at the offer server, generates and presents an offer of $15 off (STEP 345), bringing the price to within $10 of the other store.

In some cases, the parameters of the offers are predetermined. For example, a retail establishment may determine that, although the price of an item is $350, the system may automatically lower the price to $325 if a competitive price is being offered. In some instances, the system may be able to chose from multiple offers, such that users deciding between two local retail establishments are presented offers very close in price, as the users may be willing to drive a few minutes to get a better deal. Conversely, users comparing the in-store offer to a on-line offer or an offer from a distant store may not be presented such a close offer, as their desire to have the product immediately or not to travel a great distance may be worth paying slightly more.

In some embodiments, the location of the user while scanning the product may be used as a parameter that influences the updated price. For example, a user scanning a video game console at a shopping location near their home might receive more aggressive dynamic pricing than would a user scanning the product while out of state or far from home. An event indicating that a consumer elected not to purchase an item while far from home may be considered a less severe abandonment event when compared to deciding not to buy the item at their neighborhood store. Further, a series of scans at the same store (or stores near each other) may indicate that the user is seriously considering the purchase and looking for a better deal, and therefore after some number of these events, a reduction in price may trigger purchase.

If the user accepts the offer (DECISION STEP 350) the purchase process continues as described above (STEP 250). However, if the user decides not to accept the offer, a check is made to see if she is going to continue to consider purchasing the product (DECISION STEP 355). If the user decides to continue her shopping, another offer may be presented to the user, either again lowering the price and/or adding additional features such as free delivery or a free extended service contract. The new offer is presented, and the process can continue iteratively until the user decides not to complete the purchase or until an offer limit is reached. Once the purchase is abandoned and/or the offer limit is reached, the event data (number and details of offers presented, etc.) is captured and stored as “non-purchase” event data as described above (STEP 260).

A variety of factors may be considered alone or in combination in determining whether an additional offer will be made to the user. For instance, a retail establishment may set a lowest possible price for a product. If the user declines to the purchase the product at that minimum price, no further offers will be made. Alternatively, the offer limit may be defined by a maximum number of offers that may be made to a consumer, or the amount of time that has elapsed since an offer was made (e.g., time since the initial offer, time since the most recent offer, etc.). In other circumstances, whether an additional offer is made may depend on the location of the user. For example, a user who has exited the retail establishment after displaying interest in a product may be provided with additional offers to encourage purchase. The availability of a product may also affect the offer limit, such as in the case where a retail establishment is overstocked with a particular product and is willing to permit a higher number of offers with the goal of reducing its inventory.

In some embodiments, price may not be the primary determining factor driving a user's decision to complete a purchase or to abandon the transaction. In some cases, especially those in which multiple items are being purchased simultaneously, the user may be more interested in manipulating other transaction details. For example, if the user is shopping for a new gaming console, she may also be purchasing new games, additional controllers and other auxiliary devices. She may not be price sensitive to the console (because, perhaps she wants to bring it home with her that afternoon) whereas the other items she may be willing to wait for and have shipped to her home at a lower price. In such cases, the mobile application provides for “dual shopping cart” functionality in which a user may indicate within a single electronic shopping cart which items are to be taken home immediately, and which items are to be shipped separately. By providing this feature, users can instruct the retail establishment how to allocate their order without having to make two or more separate purchases. Continuing with the example above, as the user scans the console box and it is added to her electronic cart (and as she places the physical box in her actual cart) she may indicate that the item is to be “taken home.” Conversely, as she scans additional games and controllers, she may indicate that these are to be shipped separately, which may affect taxes paid, shipping costs, inventory levels (as shipped items may be sent from a central warehouse instead of the local store) and other transaction parameters.

Non-limiting examples of data that may captured using various location-aware, data capture, networking and social networking features of smartphones include the following:
when (date, time) a user enters a store and which store they are at;
when and how often a user scans an item;
access to and providing product info about an item;
access to and providing user and professional reviews about an item;
which review was viewed last prior to a purchase or non-purchase event;
the addition of an item to a shopping cart;
the removal of an item from a cart;
the addition of an item to a cart previously removed from a cart or scanned but never added;
the amount of time between events (linger time);
the purchase of an item;
quantities of items purchased for a current visit and as compared to previous visits; and
when the user leaves the store.

Capturing and analyzing shopping events such as those described herein may be used either independently or in combination (using, for example, a neural network or other predictive model) to determine optimal pricing for items, the offering of alternative or additional items, or other offers.

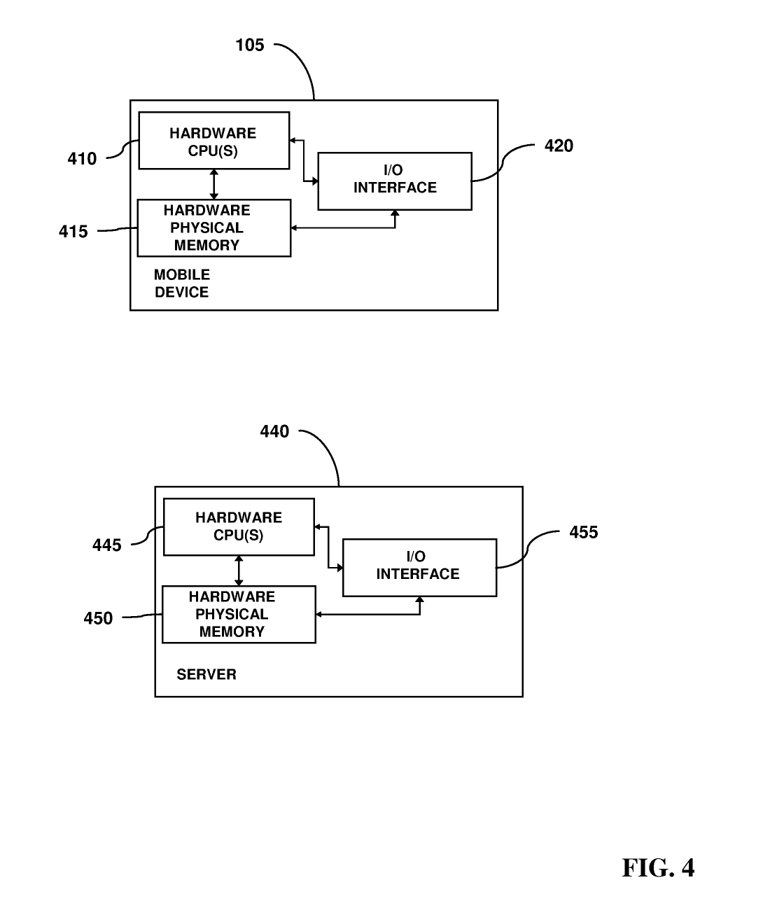

Mobile device 105 and servers 130 and 170 may be implemented in any suitable way. FIG. 4 illustrates an exemplary architecture for a mobile device 105 and a server 130 (for example, any of servers 130 or 170) that may be used in some embodiments. The mobile device 105 may include hardware central processing unit(s) (CPU) 410, operatively connected to hardware/physical memory 415 and input/output (UO) interface 420. Exemplary server 440 similarly comprises hardware CPU(s) 445, operatively connected to hardware/physical memory 450 and input/output (UO) interface 345580. Hardware/physical memory may include volatile and/or non-volatile memory. The memory may store one or more instructions to program the CPU to perform any of the functions described herein. The memory may also store one or more application programs.

Exemplary mobile device 105 and exemplary server 440 may have one or more input and output devices. These devices can be used, among other things, to present a user interface and/or communicate (e.g., via a network) with other devices or computers. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Although examples provided herein may have described the servers as residing on separate computers, it should be appreciated that the functionality of these components can be implemented on a single computer, or on any larger number of computers in a distributed fashion.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only. The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above. The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish a relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

In some embodiments the functions may be implemented as computer instructions stored in portions of a computer's random access memory to provide control logic that affects the processes described above. In such an embodiment, the program may be written in any one of a number of high-level languages, such as FORTRAN, PASCAL, C, C++, C#, Java, javascript, Tcl, or BASIC. Further, the program can be written in a script, macro, or functionality embedded in commercially available software, such as EXCEL or VISUAL BASIC. Additionally, the software may be implemented in an assembly language directed to a microprocessor resident on a computer. For example, the software can be implemented in Intel 80×86 assembly language if it is configured to run on an IBM PC or PC clone. The software may be embedded on an article of manufacture including, but not limited to, “computer-readable program means” such as a floppy disk, a hard disk, an optical disk, a magnetic tape, a PROM, an EPROM, or CD-ROM.

Variations, modifications, and other implementations of what is described herein will occur to those of ordinary skill in the art without departing from the spirit and the scope of the invention as claimed.

1. A method of capturing event data resulting from a consumer's behavior at a retail establishment, the method comprising:
obtaining, via an image acquisition component operatively connected to a mobile device, an image comprising information that identifies a product being offered for sale by a retail establishment;
transmitting the image from the mobile device to a purchase server;
receiving at the mobile device, in response, product information comprising description and price information for the product;
displaying the product information on a display of the mobile device;
identifying an event in the retail establishment representing a decision by the consumer not to purchase the product; and
transmitting the event information from the mobile device to the purchase server.

2. The method of claim 1 wherein the image comprises one or more of a bar code, an image of the product, an image of all or a portion of packaging of the product, a product name, a brand name, a serial number, and a product number.

3. The method of claim 1 wherein the product information is displayed as one or more of an image and text.

4. The method of claim 1 wherein the event comprises one or more of the consumer entering the retail establishment, a determination of a location of the consumer, the consumer scanning an image comprising information that identifies the product, capturing a time the consumer scans an image comprising information that identifies the product, addition of an item to a shopping cart, removal of an item from a shopping cart, determination of an elapsed time since a previous event, and the consumer leaving the retail establishment.

5. The method of claim 1 further comprising:
receiving at the mobile device, in response to transmitting the event information, one or more of a survey, a coupon, an invitation to a sale, and an offer for a subsequent purchase.

6. A method of capturing event data resulting from a consumer's behavior at a retail establishment, the method comprising:
obtaining, via an image acquisition component operatively connected to a mobile device, an image comprising information that identifies a product being offered for sale by a retail establishment;
transmitting the image from the mobile device to a purchase server;
receiving at the mobile device, in response, product information comprising description and price information for the product;
receiving at the mobile device instructions to search for additional product information related to the product;
comparing the product information and the additional product information on a display of the mobile device; and
updating the product information based on the comparison.

7. The method of claim 6 wherein the updated product information comprises an updated price.

8. The method of claim 6 wherein the updated product information is further based on one or more of a price difference, a location of the consumer, a location of another retail establishment offering the product, availability of the product from an online retail establishment, and a frequency the consumer scans an image comprising information that identifies the product.

9. The method of claim 6 wherein updating the product information comprises receiving at the mobile device an offer from an offer server.

10. The method of claim 9 further comprising:
determining the consumer has decided to accept the offer; and
allowing the consumer to authorize purchase of the product via the mobile device.

11. The method of claim 9 further comprising:
determining the consumer has decided not to accept the offer; and
receiving at the mobile device an updated offer from the offer server.

12. The method of claim 11 further comprising:
repeating the steps of claim 11 until the consumer either accepts the updated offer or an offer limit has been reached.

13. The method of claim 12, wherein the offer limit is based on one or more of an elapsed time since an offer, a maximum number of offers, a maximum reduction in price, a location of the consumer, and availability of the product.

14. The method of claim 6 further comprising:
identifying an event in the retail establishment representing a decision by the consumer not to purchase the product; and
transmitting the event information from the mobile device to the purchase server.

15. A system for capturing event data resulting from a consumer's behavior at a retail establishment, the system comprising a mobile device having at least one processor configured to:
obtain, via an image acquisition component an image comprising information that identifies a product being offered for sale by a retail establishment;
transmit the image to a purchase server;
receive, in response, product information comprising description and price information for the product;
identify an event in the retail establishment representing a decision by the consumer not to purchase the product; and
transmit the event information to the purchase server.

16. The system of claim 15 wherein the image comprises one or more of a bar code, an image of the product, an image of all or a portion of packaging of the product, a product name, a brand name, a serial number, and a product number.

17. The system of claim 15 wherein the product information is displayed as one or more of an image and text.

18. The system of claim 15 wherein the event comprises one or more of the consumer entering the retail establishment, a determination of a location of the consumer, the consumer scanning an image comprising information that identifies the product, capturing a time the consumer scans an image comprising information that identifies the product, addition of an item to a shopping cart, removal of an item from a shopping cart, determination of an elapsed time since a previous event, and the consumer leaving the retail establishment.

19. The system of claim 15 wherein the processor is further configured to:
receive, in response to transmitting the event information, one or more of a survey, a coupon, an invitation to a sale, and an offer for a subsequent purchase.

20. A system for capturing event data resulting from a consumer's behavior at a retail establishment, the system comprising a mobile device having at least one processor configured to:
obtain, via an image acquisition component an image comprising information that identifies a product being offered for sale by a retail establishment;
transmit the image to a purchase server;
receive product information comprising description and price information for the product;
receive instructions to search for additional product information related to the product;
compare the product information and the additional product information; and
update the product information based on the comparison.

21. The system of claim 20 wherein the updated product information comprises an updated price.

22. The system of claim 20 wherein the updated product information is further based on one or more of a price difference, a location of the consumer, a location of another retail establishment offering the product, availability of the product from an online retail establishment, and a frequency the consumer scans an image comprising information that identifies the product.

23. The system of claim 20 wherein updating the product information comprises receiving an offer from an offer server.

24. The system of claim 23 wherein the at least one processor is further configured to:
determine the consumer has decided to accept the offer; and
allow the consumer to authorize purchase of the product via the mobile device.

25. The system of claim 23 wherein the at least one processor is further configured to:
determine the consumer has decided not to accept the offer; and
receive an updated offer from the offer server.

26. The system of claim 25 wherein the processor is further configured to:
repeat the steps of claim 25 until the consumer either accepts the updated offer or an offer limit has been reached.

27. The system of claim 26 wherein the offer limit is based on one or more of an elapsed time since an offer, a maximum number of offers, a maximum reduction in price, a location of the consumer, and availability of the product.

28. The system of claim 20 wherein the at least one processor is further configured to:
identify an event in the retail establishment representing a decision by the consumer not to purchase the product; and
transmit the event information to the purchase server.

29. An article of manufacture having computer-readable program portions embodied thereon for capturing event data resulting from a consumer's use of a mobile device at a retail establishment, the article comprising computer-readable instructions for:
obtaining, via an image acquisition component operatively connected to a mobile device, an image comprising information that identifies a product being offered for sale by a retail establishment;
transmitting the image from the mobile device to a purchase server;
receiving at the mobile device, in response, product information comprising description and price information for the product;
displaying the product information on a display of the mobile device;
identifying an event in the retail establishment representing a decision by the consumer not to purchase the product; and
transmitting the event information from the mobile device to the purchase server.

30. An article of manufacture having computer-readable program portions embodied thereon for capturing event data resulting from a consumer's use of a mobile device at a retail establishment, the article comprising computer-readable instructions for:
obtaining, via an image acquisition component operatively connected to a mobile device, an image comprising information that identifies a product being offered for sale by a retail establishment;
transmitting the image from the mobile device to a purchase server;
receiving at the mobile device, in response, product information comprising description and price information for the product;
receiving at the mobile device instructions to search for additional product information related to the product;
comparing the product information and the additional product information on a display of the mobile device; and
updating the product information based on the comparison.
